(19) United States
(12) Patent Application Publication
(10) Pub. No.: US 2008/0295870 A1
(43) Pub. Date: Dec. 4, 2008

(54) CLEANING DEVICES, SYSTEMS, AND METHODS

(75) Inventors: Thomas Perelli, Winchester, VA (US); Grant M. Mason, Winchester, VA (US)

Correspondence Address: MOORE & VAN ALLEN PLLC, P.O. BOX 13706, Research Triangle Park, NC, 27709, US

(73) Assignee: Rubbermaid Commercial Products LLC, Winchester, VA (US)

(21) Appl. No.: 12/129,282

(22) Filed: May 29, 2008

Related U.S. Application Data
(60) Provisional application No. 60/940,586, filed on May 29, 2007.

(51) Int. Cl. B08B 3/04; B08B 13/00

(52) U.S. Cl. 134/42; 134/201; 134/56 R

(57) ABSTRACT

The present invention is directed to devices, systems, and methods for transferring cleaning fluid from a tank to a reservoir located on a cleaning implement. The present invention provides a fluid-transfer system that may include a pump assembly for pressurizing fluid stored in a tank and a filling dock for providing fluid communication between the tank and the cleaning implement. The filling dock may releasably secure the implement during the fluid transfer operation. In operation, the cleaning implement is attached to the filling dock, and, after attachment, cleaning fluid flows from the tank, through the filling dock, and into the reservoir of the cleaning implement.

### CROSS REFERENCE TO RELATED APPLICATIONS

This application claims benefit of priority under 35 U.S.C. §119(e) to the filing date of U.S. Provisional Application No. 60/940,586, as filed on May 29, 2007, which is incorporated herein by reference in its entirety.

### FIELD OF INVENTION

This invention relates generally to cleaning devices, systems, and methods and more particularly to devices, systems, and methods for transferring fluid from a tank located on a cart or caddie to a reservoir located on a cleaning implement.

### BACKGROUND

Cleaning implements, such as mops, often have an on-board reservoir for storing cleaning fluid and a delivery system for routing cleaning fluid from the reservoir to the mop head so as to saturate the mop head with cleaning fluid. Some of these mops include a sprayer that receives cleaning fluid from the reservoir and applies the cleaning fluid to the floor in front of or behind the mop head. The reservoir is usually attached between the handle and the mop head. Manual refilling of the reservoir is a time consuming process that can result in spillage. Also, manual refilling may expose the operator to fumes or liquids. There is a need for devices, systems, and methods that will allow for relatively quick and easy refilling of a reservoir on a cleaning implement.

### SUMMARY

According to an aspect the present invention, a cleaning system for transferring fluid from a tank to an implement may include a tank for storing cleaning fluid, and a pump in communication with the tank and configured to pressurize the cleaning fluid stored in the tank. They cleaning system may also include a filling dock and a cleaning implement that has a reservoir for storing the cleaning fluid and having a first valve. The filling dock is in communication with the tank and has a second valve connectable to the first valve such that the first and second values interconnect to permit the cleaning fluid to flow from the tank to the reservoir of the cleaning implement when the cleaning implement is secured to the filling dock.

According to another aspect of the present invention, a cart is provided. The cart may include a tank for storing fluid, a pump in communication with the tank and configured to pressurize the fluid, and a filling dock in fluid communication with the tank. The filling dock may have a valve configured to open when a cleaning implement is connected to the valve and to close when the cleaning implement is not connected to the valve. In operation, fluid passes from the tank, through the valve, and to the cleaning implement when the cleaning implement is connected to the valve.

According to yet another aspect of the present invention a cart is provided. The cart may include a tank for storing fluid, a support, a wheel supporting the support for rolling motion, and a vertically extending support extending from the support and having a filling dock in fluid communication with the tank. The filling dock may include a securing mechanism for securing a cleaning implement to the cart, and a valve configured to open when the cleaning implement is secured by the securing mechanism and to close when the cleaning implement is not secured by securing mechanism. The cart may also include a fluid line that interconnects the tank and the valve.

According to still another aspect of the present invention, a method is provided for providing fluid to a cleaning implement. The method comprises pressurizing fluid stored in a supply tank, directing fluid from the supply tank to a valve located in a filling dock, securing the cleaning implement to the filling dock, opening the valve, and directing fluid through the valve to the cleaning implement.

These and other objects, features and advantages of the present invention will be apparent from the following description thereof and appended claims in which references are made to the accompanying drawings.

### BRIEF DESCRIPTION OF THE DRAWINGS

For a more complete understanding of the present invention, reference should now be had to the embodiments shown in the accompanying drawings and described below. In the drawings:

FIG. 1 is a front perspective view of fluid-transfer system for use in a cart according to an embodiment of the present invention. Portions of the cart are removed for illustrative purposes.

FIG. 2 is a side view of the janitor cart having the filling system of FIG. 1.

FIG. 3 is a side perspective view of a cleaning implement for use with the filling system of FIG. 1.

FIG. 4 is a perspective view of the pullout shelf, pump assembly, and supply tank of the filling system of FIG. 1.

FIG. 5 is an exploded perspective view of the pullout shelf, pump assembly, and supply tank of FIG. 4.

FIG. 6 is a front perspective view of the filling dock of the filling system of FIG. 1.

FIG. 7 is a bottom view of the filling dock of FIG. 6.

FIG. 8 is a close-up perspective view of the filling dock of the filling system of FIG. 6.

FIG. 9 is a block diagram showing a method of using the fluid-transfer system to transfer fluid from a tank to a cleaning implement.

FIG. 10 is a front perspective view of another filling system for use in a cart according to another embodiment of the present invention.

FIG. 11 is a side view of yet another filling system for use in a cart according to yet another embodiment of the present invention.

FIG. 12 is a side view of an embodiment of a stationary filling system.

### DESCRIPTION

Certain terminology is used herein for convenience only and is not to be taken as a limitation on the invention. For example, words such as “upper,” “lower,” “left,” “right,” “horizontal,” “vertical,” “upward,” “transverse” and “downward” merely describe the configuration shown in the FIGs. Indeed, the components may be oriented in any direction and the terminology, therefore, should be understood as encompassing such variations unless specified otherwise.

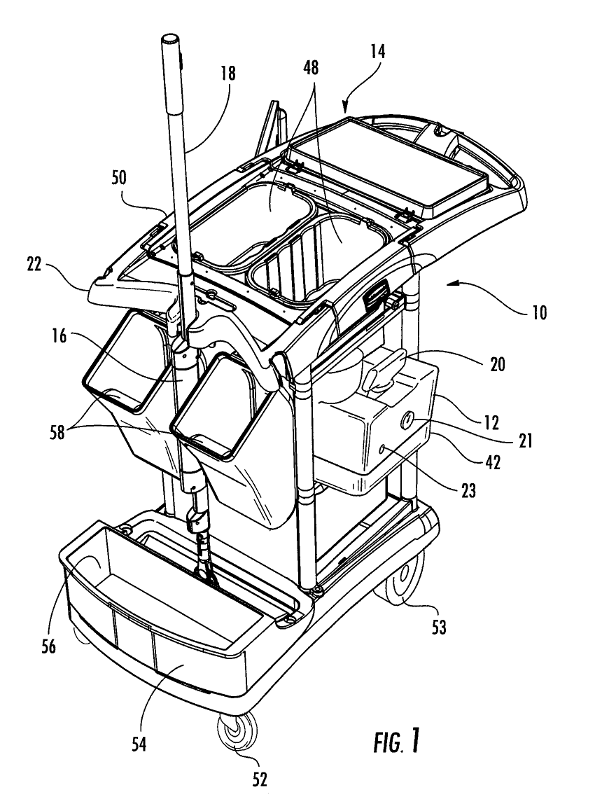

Referring now to the drawings, wherein like reference numerals designate corresponding or similar elements throughout the several view, various show embodiments of a fluid-transfer system according to the present invention are shown and generally designated at 10. According to the embodiment illustrated in FIGS. 1-3, the fluid-transfer system 10 transfers fluid from a tank 12 located on a cart 14 to a reservoir 16 located on a cleaning implement 18. The fluid-transfer system 10 includes a pump assembly 20 for pressurizing fluid stored in the tank 12 and a filling dock 22 for establishing fluid communication between the reservoir 16 and the tank 12. Also, the filling dock 22 releasably secures the implement 18 to the cart 14. It should be appreciated that the pump assembly 20 can be any means known in the art for pressurizing the fluid in the tank 12, and it should be appreciated that any type of pump may be applied in any of the embodiments of the present invention disclosed herein. For example, the pump assembly may be, but is not limited to, a hand, wheel, foot, battery or electric operated pump.

An operator can use the fluid-transfer system 10 to quickly and easily refill the reservoir 16 of the cleaning implement 18 without spilling cleaning fluid and without exposure to cleaning liquid or fumes. To do so, the operator attaches the cleaning implement 18 to the filling dock 22, and, after attachment, cleaning fluid automatically flows from the tank 12, through the filling dock 22, and into the reservoir 16 of the cleaning implement 18. In instances where the cleaning fluid in the tank 12 is not adequately pressurized for fluid transfer, the user, in addition to attaching the implement 18, actuates the pump assembly 20 to pressurize the cleaning fluid. It should be appreciated that the user may actuate the pump assembly 20 either before or after attaching the implement 18. This pressurization enables the cleaning fluid to flow from the tank 12 to the reservoir 16.

After attaching the cleaning implement 18 and, if pressurization is needed, actuating the pump assembly 20, the user does not have to take any further steps to refill the implement's reservoir 16. Accordingly, while the fluid-transfer system 10 is refilling the reservoir 16, the user can turn to unrelated tasks. This reduces time and costs associated with cleaning. In addition to reducing time and costs, the fluid-transfer system 10 reduces exposure to the cleaning fluid or fumes emitted by the cleaning fluid. This is because the fluid-transfer system 10 is a closed system and because the operator can refill the reservoir 16 by merely securing the cleaning implement 18 to the filling dock 22, without having to handle or manually fill either the tank 12 or the reservoir 16.

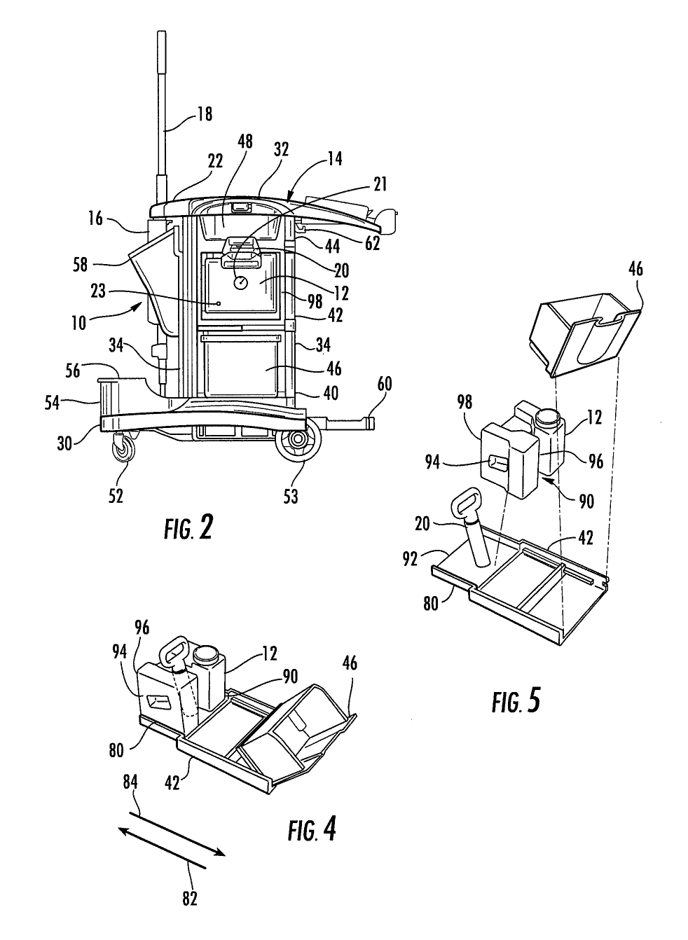

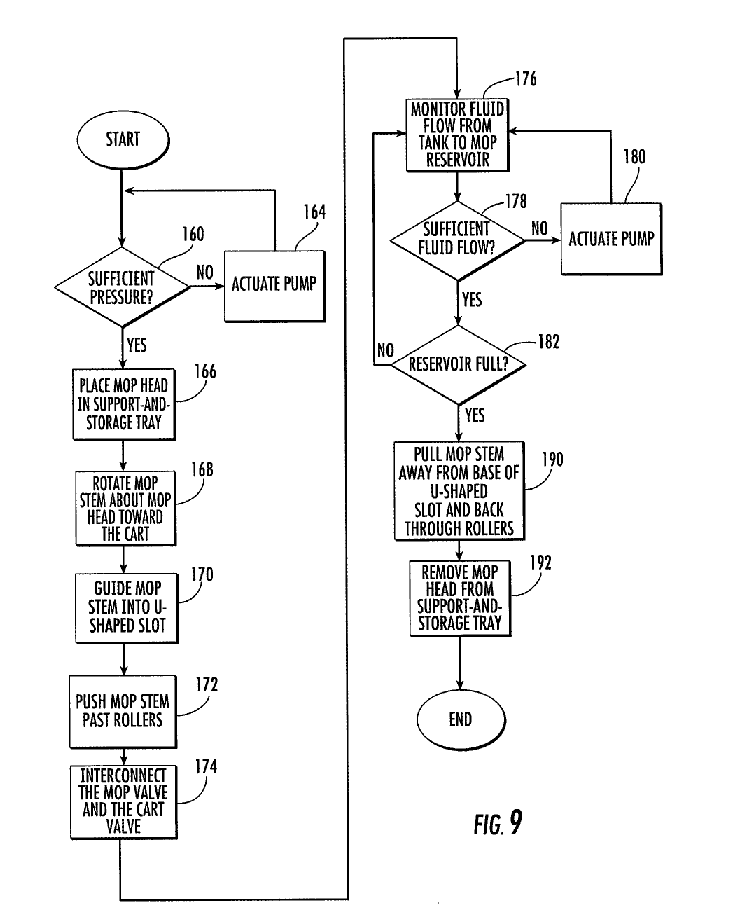

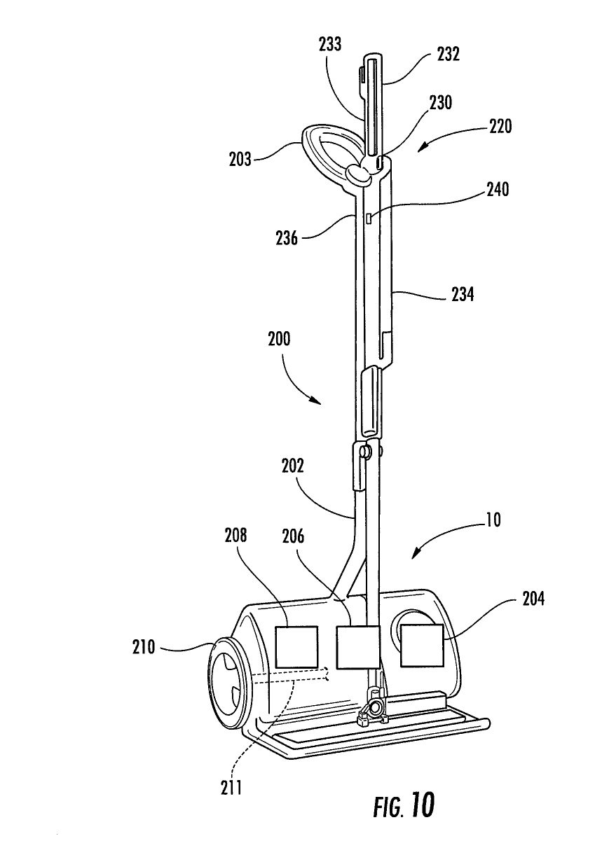

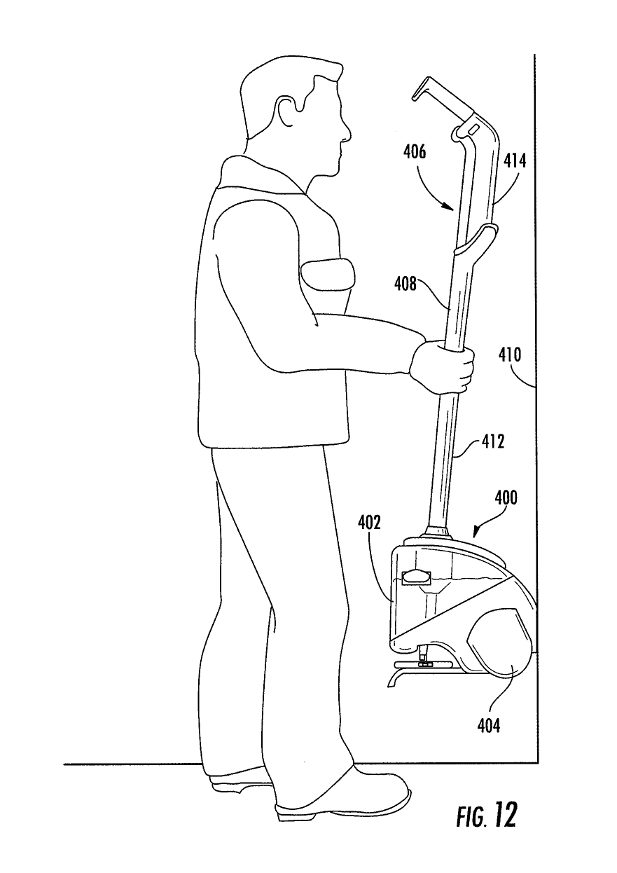

According to the embodiments illustrated in FIGS. 1-8, the cart 14 is a four-wheeled janitor cart and the cleaning implement 18 is a mop. It should be appreciated that the cart 14 can be any mobile or non-mobile structure suitable for accommodating the fluid-transfer system 10 and the cleaning implement. It should also be appreciated that the cleaning implement can be any cleaning device having an on-board reservoir for locally storing cleaning fluid including a hand held spray bottle. The cart illustrated in FIGS. 1 and 2 is intended for mobile operation. The cart may be a wheeled device that connects to another cart, such as a conventional cleaning cart, such that the cart may be attached to and pulled behind the conventional cart. Reference is made to FIG. 11, where a smaller cart 300 having a tank 302 and pump 304 may be attached to a conventional cleaning cart by a tether 306 or used as a stand alone device.

As illustrated in FIG. 12, a separate docking station 400 may be provided for retaining a fluid tank 402 and a pump assembly 404, and for releaseably holding a cleaning implement 406. The docking station 400, for example, may be a fixed structure such as a free standing support or, like the embodiment illustrated in FIG. 12, the docking station 400 may be a mounted support fixed to the wall 410 of a structure. The docking station 400 may include a vertically extending arm 412 for releasably holding the cleaning implement 406. The pump assembly 404 may be an electric pump for pressurizing fluid inside of the fluid tank 402 that is powered from a fixed electrical source such as a building's wall outlet. Cleaning fluid, which is pressurized by the pump assembly 404, may be transmitted from the fluid tank 402, through a conduit 408 associated with the vertically extending arm 412, and into a reservoir 414 associated with the cleaning implement 406 when the cleaning implement 406 is connected to the docking station 400 and releasably held by the vertically extending arm 412.

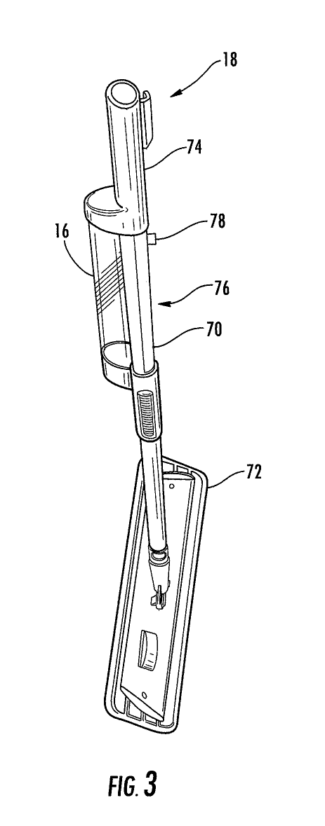

The janitor cart 14, as illustrated in FIGS. 1 and 2, is similar to the cart disclosed in commonly owned US 2006/0163827, which is incorporated herein in its entirety. The cart 14 includes a base 30 and a top 32 separated by vertically extending support members 34. Bottom, middle, and top selves 40, 42, 44 are provided between the base 30 and top 32. Bins 46 can be connected to the bottom and middle shelves 40, 42. It should be appreciated that bins 46 may open and close in any manner know to those having skill in the art. For example bins 46 may be pullout or folding bins which move between an open (FIG. 4) and closed positions (FIG. 2). In the illustrated embodiments, the tank 12 and pump 20 are supported on the middle shelf 42. However, it should be appreciated that the tank 12 and pump 20 may be supported anywhere on the cart 14, including, but not limited to, bottom and top shelves 40, 44. Receptacles 48 rest on the top shelf 44 and are supported by an opening 50 formed in the top 32 of the cart 14.

Rolling members 52 and 53 are provided underneath the base 30. The rolling members may be, for example, casters, wheels, or the like. In FIGS. 1 and 2, the rolling members 52 are casters while the rolling members 53 are wheels. In the case of the casters, the casters 52 are inserted into and secured within caster sockets at the corners underneath the base 30 in a conventional fashion. In the case of the wheels 53, an axle and wheel assembly is employed in which the axle fits within an axle socket in a snap fit fashion and wheels are secured to opposite ends of the axle in a conventional manner. In another embodiment, both the rolling members 52 and 53 can be casters. Although the cart shown in FIGS. 1 and 2 contemplates the use of two small rolling members and two large rolling members, the cart of the present invention may have the rolling members 52 and 53 be the same size. In addition, the cart may have more or less than four rolling members. Numerous changes in the configuration of the cart can be made.

A support-and-storage tray 54 is provided atop the base 30, adjacent the bottom shelf 40. The support-and-storage tray 54 supports one end of the mop 18 while a user secures the other end of the mop 18 to the filling dock 22, and the support-and-storage tray 54 continues supporting the mop 18 after the mop 18 has been secured to the filling dock 22. The support-and-storage tray 54 includes a bin 56 for storing clean mop pads.

For example, the user can easily and quickly attach a clean pad to the mop 18 by pressing the mop onto a Velcro(t side of the pad. Accordingly, the user does not have to bend down or use his hands when attaching a clean pad.

Bulk storage bins 58 are provided for storing, among other things, spoiled mop pads. The bulk storage bins 58 are removably attached to facilitate cleaning thereof, and the bins 58 are angle toward to the user for easy access. A folding shelf 60 is attached to the base 30 and moves between retracted and extended positions. In the extended position, as shown in FIG. 2, the folding shelf 160 can, among other things, support a trash bag (not shown) hanging from hook 62.

The mop 18, as illustrated in FIG. 3, includes a stem 70 having a head 72, that may be movably mounted, on one end and a handle 74 on the other end. The reservoir 16 is attached to a middle portion 76 of the stem 70. A valve 78 is provided for permitting cleaning fluid to flow into the reservoir 16 when the mop 18 is secured to the filling dock 18. During use, for example, fluid flows from the reservoir 16 to the head 72 so as to provide cleaning fluid to the head 72 and thereby facilitate cleaning operations. The mop may be a pressurized system, a gravity fed system or the like.

FIG. 4 is a perspective view of the middle shelf 42 having the tank 12, pump assembly 20, and the folding bin 46 disposed thereon. For illustrative purposes, the middle shelf 42 is shown in FIG. 4 separate from the rest of the cart 14. FIG. 5 is an exploded view of FIG. 4.

The pump assembly 20 and the tank 12 are located on a pullout shelf 80 that moves, within the middle shelf 42, in directions 82, 84. The pullout shelf 80 moves in direction 82 to an extended position and in direction 84 to a retracted position. When the pullout shelf 80 is in the extended position, the tank 12 and the pump assembly 20 extend outward, away from the rest of the cart 14. Accordingly, when the pullout shelf 80 is in the extended position, the tank 12 and pump assembly 20 are easily accessible. What's more, because the pullout shelf 80, including the tank 12 and the pump assembly 20, is located on the middle shelf 42, a user does not have to bend over very far when actuating the pump assembly 20 and/or refilling the tank 12.

A cutout 90 is formed in the tank 12 for accommodating the pump assembly 20. The tank 12 rests on a top surface 92 of the pullout shelf 80 and the cutout 90 encloses the pump assembly 20, which is attached to and extends from the top surface 92. The pump assembly 20 is in fluid communication with the interior of tank 12 such that activation of the pump assembly 20 forces gas, such as ambient air, into the tank 12 to pressurize the fluid in the tank 12. The tank 12 may include a pressure-release vent 23 configured to release air when the pressure inside of the tank reaches a maximum pressure. Accordingly, the pressure-release vent 23 prevents over pressurization and thereby preventing damage to the components of the fluid-transfer system. Additionally, the pressure-release acts as a maximum-pressure indicator. For example, the pressure-release valve indicates that the fluid in the tank has reached maximum pressure by emitting air. While the described pump assembly is a hand pump, it should be appreciated that the pump assembly may be a battery-operated pump.

Because the cutout 90 is formed in side 96 of the tank 20 and not side 98, the tank 12 has an asymmetrical weight distribution. The center of gravity of the tank 12 is closer to side 98 than side 96. To remove the tank 12 from the pullout shelf 80, a user may approach the tank from side 98 and grip handles 94, which are slightly angled for comfort. Because the center of gravity is close to the user, a reduced moment acts on the user's back when the user lifts the tank 12 from the pullout shelf 80.

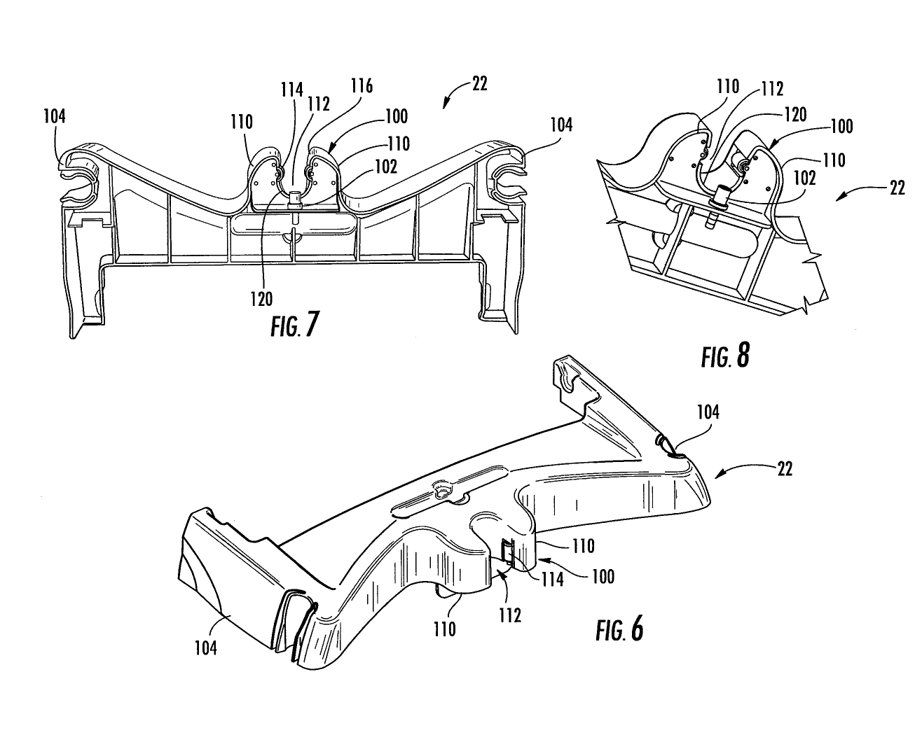

Referring now to FIGS. 6-8, the filling dock 22 includes a securing mechanism 100 and a valve 102. The securing mechanism secures the mop 18 to the cart, and the valve 102 establishes fluid communication between the tank 12 and the reservoir 16 of the mop 18.

The securing mechanism 100 includes a pair of horizontally extending legs 110 and a u-shaped slot 112 formed between the legs 110. The u-shaped slot 112 is sized to receive the stem 70 of the mop 18. A roller 114 is provided on an inside surface 116 of each leg 110 so as to provide a pair of rollers 114 in a facing relationship. The rollers 114 secure the stem 70 of the mop 18 in the unshaped slot 112. To secure the mop 18 to the cart 14, a user guides the stem 70 into the u-shaped slot 112 and the forces the stem 70 past the rollers 114 and into contact with a base 120 of the u-shaped slot 112. An equal and opposite force is required to remove the stem 70 from the u-shaped slot 112. Accordingly, the mop 18 is relatively secure when the stem 70 is positioned behind the rollers 114.

Valve 102 is provided at the base 120 of the u-shape slot 112 and extends into the u-shaped slot 112 so as to automatically engage and interconnect with the valve 78 of the mop 18 when the mop stem 70 is secured in the securing mechanism 22. Because the valve 102 of the filling dock 22 is in fluid communication with the tank 12 and the valve 78 of the mop 18 is in fluid communication with the reservoir 16 of the mop 18, this interconnection between valves 78 and 102 establishes fluid communication between the reservoir 16 of the mop 18 and the tank 12. Valves 78 and 102 are open when interconnected. Otherwise, valves 78 and 102 are closed to prevent spillage. Accordingly, the valves 78 and 102 are open when the mop 18 is properly secured to the cart 14, and the valves 78 and 102 are closed when the mop 18 is not secured to the cart 14.

A method of using the fluid-transfer system 10 to transfer fluid from the tank 12 to the reservoir 16 of the mop 18 will now be described with reference to FIG. 9. It should be appreciated that the mop 18 may be secured to the cart 14 at the outset of this method. First, a user determines whether the pressure of the fluid in the tank 12 is sufficient to facilitate fluid transfer (block 160). For example, to determine fluid pressure, the user may utilize a conventional pressure gauge and compare the measured pressure to a predetermined minimum-operating pressure, which is the minimum amount of pressure required to effectively transfer fluid. Also, for example, a maximum-minimum pressure indicator 21 may be provided to indicate whether fluid in the tank 12 is pressurized a sufficient amount. It is also possible that the user can determine if the pressure is sufficient simply by coupling the mop to the system and observing if fluid flow occurs It should be appreciated that valves 78 and 102 can be manually connected and disconnected to and from each other, and manually opened and closed. This permits manual opening and closing of the valves, for example, to bleed gas from the tank 12 and/or reservoir 16 when the mop 18 is disconnected from the cart 14.

If the existing pressure is less than the minimum-operating pressure, then the user actuates the pump assembly 20 and thereby increases the fluid pressure (block 164). The user may reference the maximum-minimum pressure indicator 21 when operating the pump to pressurize the fluid in the tank. For example, the user may deactivate the pump 20 when the maximum-minimum pressure indicator 21 indicates that maximum pressure has been obtained. It should be appreciated that the user may deactivate the pump when air begins to flow from pressure-release vent 23, indicating that the maximum pressure has been reached. In the illustrated embodiment, the pump assembly 20 is a hand pump that the user can manually pump to increase fluid pressure. After actuating the pump assembly, the user, again, determines if the pressure is suitable for fluid flow (block 160).

If the pressure equals or exceeds the minimum-operating pressure (for example, if the maximum-minimum pressure indicator 21 indicates that pressure is between the maximum and minimum limits) then the fluid-transfer system 10 is ready for operation. If the mop 18 is not already secured to the cart 14, then the user places the mop head 72 in the support-and-storage tray 54 (block 166) and then rotates the mop stem 70, about the mop head 72, toward the filling dock 22 of the cart 14 (block 168). Next, the user guides the stem 70 into the u-shaped slot 112 (block 170) and then pushes the stem 70 past the rollers 114 to a position proximate the base 120 of the u-shaped slot 112 (block 172). This secures the mop 18 to the cart 14 and interconnects the valve 78 of the mop 18 and the valve 102 of the filling dock 22 (block 174). Accordingly, at block 174, fluid communication between the reservoir 16 of the mop 18 and the tank 12 is established.

Because the fluid in tank 12 is pressurized, fluid begins to flow from the tank 12 to the reservoir 16 of the mop 18 when the valve 78 of the mop 18 and the valve 102 of the filling dock 22 interconnect and fluid communication is established. Once fluid flow begins, the user monitors the fluid flow (block 176) and determines whether the fluid flow is sufficient (block 178). For example, the user can monitor fluid flow by watching fluid flow through conduits and into the reservoir 16 of the mop 18, or the user can monitor a flow meter. If the flow rate is not sufficient, e.g., the flow is too slow or the flow has stopped, the user then actuates the pump assembly 20 to pressurize fluid in the tank 12 (block 180) and then continues monitoring the flow (block 176).

The user next determines whether the reservoir 16 of the mop 18 is full (block 182). For example, the reservoir 16 of the mop 18 may be transparent and the user can determine whether the reservoir 16 is full by looking at the fluid level. Also, for example the fluid reservoir 16 may be equipped with a fluid level indicator. If the reservoir 16 of the mop 18 is not full, the user continues to monitor the fluid flow (block 176). Once the reservoir 16 of the mop 18 is full, the user disconnects the valve 78 of the mop 18 from the valve 102 of the filling dock 22 and removes the mop 18 from the cart 14 by pulling the stem 70 back through the rollers 114 and out of the u-shaped slot 112 (block 190). Finally, the user removes the mop head 72 from the support-and-storage tray 54.

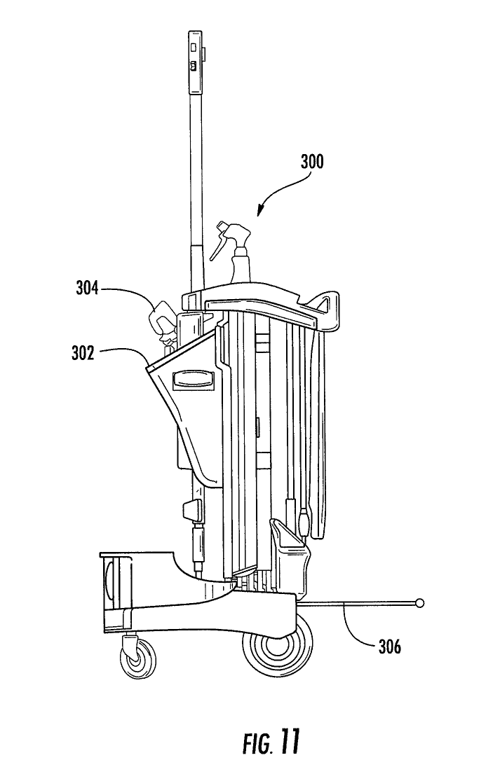

Another embodiment of the fluid-flow system 10 will now be described with reference to FIG. 10. The fluid-flow system 10 is used in a two-wheeled cart 200 having a vertically extending handle 202 for pushing or pulling the cart. For purposes of convenience, the cart 200 is referred to herein as a caddie. As illustrated in FIG. 10, the fluid flow system 10 includes a tank 204 for storing unpressurized fluid and a wheel pump 206 associated with at least a wheel 210 of the caddie 200. The wheel pump 206 is in fluid communication with both the tank 204 and an expandable bladder 208, which is located at another position away from the tank 204. As the caddie 202 is pushed or pulled, the rotation of an axle 211 associated with the wheel 210 actuates the wheel pump 206. The actuated wheel pump 206 pulls fluid from the unpressurized tank 204 and pushes the fluid to the expandable bladder 208. This builds pressure in the expandable bladder 208, and, accordingly, enables the expandable bladder to output fluid at a constant pressure. A return passage and pressure relief valve are provided between the bladder 208 and the tank 204 for allowing fluid to flow from the bladder 208 to the tank 204 when the fluid in the bladder 208 reaches a maximum pressure. It should be appreciated that, instead of the wheel pump 206, a hand pump, as disclosed in FIGS. 1-8, or a battery powered pump may be used to pull the fluid from the tank 204 and push the fluid to the bladder 208. Further, the wheel pump 206 may be used with the embodiment described with reference to FIG. 1.

The fluid-flow system 10, as illustrated in FIG. 10, also includes a filling dock 220 in fluid communication with the bladder 208. The filling dock 220 includes a securing mechanism 230 and a valve 236, as previously discussed. The securing mechanism 230 secures a cleaning implement 232 having an on-board reservoir 234 to the caddie 202. The valve 236 of the filling dock 220 interconnects with a valve 240 located on the reservoir 234 of the cleaning implement 232 when the cleaning implement is secured to the caddie 202. A fluid line (not shown) fluidly interconnects connects the valve 236 of the filling dock 220 to the expandable bladder 208. The expandable bladder 208, when containing a sufficient amount of fluid, provides a constant pressure on the fluid line.

The interconnection between the valve 236 of the filling dock and the valve 240 of the reservoir establishes fluid communication between the reservoir 234 of the cleaning implement 232 and the expandable bladder 208, which, as previously mentioned, receives fluid from the tank 204 by way of the wheel pump 206. As such, when the cleaning implement 232 is secured to the filling dock 220 of the caddie 202, the expandable bladder 208 automatically pushes fluid through the fluid line, through valves 236 and 240, and into the reservoir 234. In the illustrated embodiment, the handle 202 includes a grip 203 that can be used to move the caddie 200. It should be appreciated that handle 202 and grip 203 could be removed and that a handle 233 of the implement 232 could be used to move the caddie 200.

The caddie as described with reference to FIG. 10 may be modified and used as the docking station 400 shown in FIG. 12. Specifically the wheels may be removed from the caddie 200 and the caddie could be placed or secured on a stationary surface, such as fastened to a wall. Cover plates could be used to cover the wheel wells to provide the stationary unit with a finished appearance. In this manner the caddie 200 could function both as a mobile system as described with reference to FIG. 10 and as a stationary system as described with reference to FIG. 12. When used as a stationary system the pump could be electrically powered by being wired to a power source such as a building's electrical system.

Although the present invention has been shown and described in considerable detail with respect to only a few/particular exemplary embodiments thereof, it should be understood by those skilled in the art that it is not intended to limit the invention to the embodiments since various modifications, omissions and additions may be made to the disclosed embodiments without materially departing from the novel teachings and advantages of the invention, particularly in light of the foregoing teachings.

I claim:

1. A cleaning system, comprising:
a tank for storing cleaning fluid;
a pump in communication with the tank and configured to pressurize the cleaning fluid stored in the tank;
a cleaning implement having a reservoir for storing the cleaning fluid, the reservoir has a first valve; and
a filling dock in communication with the tank and having a second valve connectable to the first valve such that the first and second values interconnect to permit the cleaning fluid to flow from the tank to the reservoir of the cleaning implement when the cleaning implement is secured to the filling dock.

2. The cleaning system of claim 1, further comprising:
a securing mechanism for releasably securing the cleaning implement to the filling dock.

3. The cleaning system of claim 2, wherein the securing mechanism of the filling dock comprises:
a pair of extending legs;
a slot formed between the legs; and
a securing roller arranged on an inner surface of at least one of the legs,
wherein the securing rollers secure the cleaning implement in the slot.

4. The cleaning system of claim 3, wherein the second valve of the filling dock extends into the slot and interconnects with the first valve of the reservoir when the cleaning implement is secured to the filling dock.

5. A cart, comprising:
a tank for storing fluid;
a pump in communication with the tank and configured to pressurize the fluid; and
a filling dock in fluid communication with the tank and having a valve configured to open when a cleaning implement is connected to said valve and to close when the cleaning implement is not connected to said valve,
wherein fluid passes from the tank, through the valve, and to the cleaning implement when the cleaning implement is connected to said valve.

6. The cart of claim 5, further comprising:
a securing mechanism for securing the cleaning implement to the filling dock.

7. The cart of claim 5, further comprising:
a base; and
a plurality of rolling support members.

8. The cart of claim 5, wherein the filling dock horizontally extends from the cart.

9. The cart of claim 6, wherein the securing mechanism comprises:
a pair of extending legs;
a slot formed between the legs; and
a securing roller arranged on an inner surface of at least one of the legs for securing the cleaning implement in the slot.

10. The cart of claim 9, wherein the securing rollers are oppositely arranged in a facing relationship.

11. The cart of claim 9, wherein the valve of the filling dock extends into the slot and interconnects with a second valve located on a reservoir of the cleaning implement when the cleaning implement is secured to the filling dock.

12. The cart of claim 9, wherein the interconnection of the valve of the filling dock and the second valve of the reservoir establishes fluid communication between the tank and the reservoir.

13. The cart of claim 6, further comprising:
a tray supporting a head of the cleaning implement when a stem of the cleaning implement is secured by the securing mechanism.

14. The cart of claim 13, wherein the tray comprises a bin for storing a plurality of clean pads.

15. The cart of claim 5, further comprising:
a pullout shelf movable between retracted and extended positions, wherein the tank is disposed on the pullout shelf.

16. The cart of claim 5, wherein a cutout is formed in the tank for accommodating the pump.

17. A cart, comprising:
a tank for storing fluid;
a support;
a wheel supporting the support for rolling motion;
a vertically extending support extending from the support and having a filling dock in fluid communication with the tank, the filling dock comprising:
a securing mechanism for securing a cleaning implement to the cart; and
a valve configured to open when the cleaning implement is secured by the securing mechanism and to close when the cleaning implement is not secured by securing mechanism; and
a fluid line that interconnects the tank and the valve.

18. The cart of claim 17, further comprising:
a bladder; and
a wheel pump associated with the wheel and in fluid communication with the tank and the bladder, the wheel pump is configured to pump fluid from the tank to the bladder.

19. The cart of claim 18, wherein the bladder provides a constant pressure in the fluid line and thereby directs fluid to the cleaning implement when the valve is open.

20. The cart of claim 17, wherein the wheel is two wheels.

21. The cart of claim 17, wherein the vertically extending support includes a handle.

22. A method for providing fluid to a cleaning implement, the method comprising:
pressurizing fluid stored in a supply tank;
directing fluid from the supply tank to a valve located on a filling dock;
securing the cleaning implement to the filling dock;
opening the valve; and
directing fluid through the valve to the cleaning implement.

23. The method of claim 22, wherein pressurizing fluid comprises:
activating a pump associated with the tank.

24. The method of claim 22, wherein securing the cleaning implement to the filling dock comprises:
placing a head of the cleaning implement in a support-and-storage tray;
pivoting a stem of the cleaning implement, about the head, toward a slot formed in the filling dock; and
pushing the handle into the slot and beyond a pair of oppositely arranged securing rollers.

25. The method of claim 24, wherein opening the valve comprises:
interconnecting the valve of the filling dock with a second valve located on the cleaning implement.

26. The method of claim 22, wherein directing fluid to the cleaning implement comprises:
routing fluid through the valve and the second valve to a reservoir located on the cleaning implement.
